(19) United States
(12) Patent Application Publication
(10) Pub. No.: US 2025/0346091 A1
(43) Pub. Date: Nov. 13, 2025

(54) VACUUM THERMAL INSULATOR FOR VEHICLE, METHOD OF MANUFACTURING VEHICLE PART USING SAME, AND VEHICLE ROOF STRUCTURE INCLUDING THE VEHICLE PART

(71) Applicants: HYUNDAI MOTOR COMPANY, SEOUL (KR); KIA CORPORATION, SEOUL (KR); NVH KOREA, INC., Hwaseong-si (KR)

(72) Inventors: Ji Seob PARK, Hwaseong-si (KR); Ji Yun HA, Hwaseong-si (KR); Jin Ho HWANG, Hwaseong-si (KR); Chi Bong OH, Hwaseong-si (KR); Myung Sik LEE, Hwaseong-si (KR)

(21) Appl. No.: 18/927,369

(22) Filed: Oct. 25, 2024

(30) Foreign Application Priority Data
May 7, 2024 (KR) 10-2024-0059775

(51) Int. Cl. B60H 1/00; B32B 3/26; B32B 15/14; B32B 15/18; B32B 15/20; B60H 1/24; B60R 13/02

(52) U.S. Cl. CPC B60H 1/00564; B32B 3/266; B32B 15/14; B60H 1/245; B60R 13/0218; B32B 15/18; B32B 15/20; B32B 2307/304; B32B 2605/00; B60R 2013/0287

(57) ABSTRACT

Disclosed is a vacuum thermal insulator for vehicles that has excellent sound insulation and thermal insulation performance and is easy to process and mold the shape of a part, the vacuum thermal insulator including a thermal insulator, a support disposed in the thermal insulator and configured to maintain the product shape of the vacuum thermal insulator, and an outer shell material configured to surround the thermal insulator and joined to the outer surface of the thermal insulator in a vacuum compressed state to seal and maintain an internal space in which the thermal insulator and the support are accommodated in a vacuum.

### CROSS-REFERENCE TO RELATED APPLICATION

This application claims, under 35 U.S.C. § 119(a), the benefit of priority from Korean Patent Application No. 10-2024-0059775, filed on May 7, 2024, the entire contents of which are incorporated herein by reference.

### BACKGROUND

### (a) Technical Field

The present disclosure relates to a vacuum thermal insulator capable of being manufactured into a desired part shape to manufacture a vehicle part, a method of manufacturing a vehicle part using the same, and a vehicle roof structure including the vehicle part.

### (b) Background Art

In order to improve fuel efficiency and increase driving range when driving vehicles, it is necessary to minimize energy that is unnecessarily wasted or lost in vehicles. In particular, for electric vehicles without an internal combustion engine (ICE), increasing driving range using electric energy efficiently is regarded as very important in terms of marketability and usability of vehicles.

Electric vehicles perform driving or air conditioning using electric energy stored in the battery. In addition, the vehicles must be stopped during charging of the battery using a fast charging device, and it takes much longer to charge the battery than when refueling general internal combustion engine vehicles.

Accordingly, it is essential to increase the driving range of electric vehicles by efficient use of energy during vehicle operation. In particular, since the proportion of energy consumed for cooling and heating is high in electric vehicles, it is necessary to improve thermal efficiency through indoor heat management.

To this end, applying a thermal insulation material to a vehicle part may be considered. For example, a part molded in the form of felt or board may be used for the vehicle roof (i.e., ceiling) structure. By attaching a part molded from such a material to the roof, it is possible not only to block noise from entering the inside from the outside of the vehicle but also to improve thermal insulation between the inside and outside of the vehicle.

Although conventional vehicle roof part materials may be said to have good sound absorption or sound insulation performance for noise coming from outside the vehicle, there is a problem in that the insulation effect against heat introduced from the outside of the vehicle or heat escaping out of the vehicle is minimal.

### SUMMARY

Therefore, the present disclosure has been made keeping in mind the problems encountered in the related art, and an object of the present disclosure is to provide a vacuum thermal insulator for vehicles that has excellent sound insulation and thermal insulation performance and is easy to process and mold into a part shape.

In order to accomplish the above object, an embodiment of the present disclosure provides a vacuum thermal insulator for a vehicle, including a thermal insulator, a support disposed in the thermal insulator and configured to maintain a product shape of the vacuum thermal insulator, and an outer shell material configured to surround the thermal insulator and joined to an outer surface of the thermal insulator in a vacuum compressed state to seal and maintain an internal space in which the thermal insulator and the support are accommodated in a vacuum.

Here, the support may be a perforated metal plate with a plurality of holes formed therein and molded into a predetermined shape in consideration of the product shape of the vacuum thermal insulator.

Also, the support may include an aluminum alloy plate or a stainless steel plate.

Also, the outer shell material may be a metal composite film in which any one metal selected from the group consisting of aluminum, gold, silver, copper, nickel, cobalt, chromium, and tin is stacked on a surface of a film material.

Also, the support and the outer shell material may be spaced apart with the thermal insulator interposed therebetween so as not to be in contact with each other.

Also, the vacuum thermal insulator according to an embodiment of the present disclosure may be provided as a vehicle part.

Also, the vehicle part may be a roof duct attached to a headlining and configured to receive heated air for indoor heating or cooled air for indoor cooling from an air conditioning device and guide the air to a roof vent for discharge inside.

It may be provided as a roof duct attached to a headlining and configured to receive heated air for indoor heating or cooled air for indoor cooling from an air conditioning device and guide the air to a roof vent for discharge inside.

Another embodiment of the present disclosure provides a method of manufacturing a vehicle part, including manufacturing a perforated plate with a plurality of holes formed therein by perforating a metal plate, molding the perforated plate into a predetermined shape in consideration of a shape of a part, applying an adhesive onto a predetermined portion including an edge portion of the perforated plate, stacking a thermal insulator on each of both sides of the perforated plate and stacking an outer shell material on an outer surface of the stacked thermal insulator, and performing a vacuum compression process of applying vacuum pressure between outer shell materials at both sides and applying heat and pressure to the outer shell materials, in which a support made of the perforated plate may be disposed in the thermal insulator, and the outer shell material may be configured to surround the thermal insulator and joined to the outer surface of the thermal insulator in a vacuum compressed state to seal and maintain an internal space in which the thermal insulator and the support are accommodated in a vacuum.

In some embodiments, the metal plate may be an aluminum alloy plate or a stainless steel plate.

Also, the outer shell material may be a metal composite film in which any one metal selected from the group consisting of aluminum, gold, silver, copper, nickel, cobalt, chromium, and tin is stacked on a surface of a film material. Also, in performing the vacuum compression process, the support

and the outer shell material after vacuum compression may be spaced apart with the thermal insulator interposed therebetween so as not to be in contact with each other.

Also, the vehicle part may be a roof duct attached to a headlining and configured to receive heated air for indoor heating or cooled air for indoor cooling from an air conditioning device and guide the air to a roof vent for discharge inside.

Still another embodiment of the present disclosure provides a roof structure, including a roof duct including a thermal insulator, a support disposed in the thermal insulator and configured to maintain a shape of a part, and an outer shell material configured to surround the thermal insulator and joined to an outer surface of the thermal insulator in a vacuum compressed state to seal and maintain an internal space in which the thermal insulator and the support are accommodated in a vacuum, and a headlining to which the roof duct is attached, in which an edge portion of the roof duct may be adhered and fixed to the headlining by an adhesive.

In some embodiments the adhesive may be a silicone adhesive.

Also, a heat-resistant tape may be adhered and fixed to the edge portion of the roof duct, and the roof duct may be adhered and fixed to the headlining by the adhesive applied onto the heat-resistant tape.

### BRIEF DESCRIPTION OF THE DRAWINGS

The above and other features of the present disclosure will now be described in detail referring to certain exemplary embodiments thereof illustrated in the accompanying drawings, which are given hereinbelow by way of illustration only, and thus are not limitative of the present disclosure, and wherein:

FIG. 1 is a cross-sectional view showing the installation state of a roof duct to which a vacuum thermal insulator according to the present disclosure is applied;

FIG. 2 shows the installation region of the roof duct to which the vacuum thermal insulator according to the present disclosure is applied;

FIG. 3 is a cross-sectional view showing the configuration of the vacuum thermal insulator according to an embodiment of the present disclosure;

FIG. 4 is a schematic of the arrangement of a support in a vacuum thermal insulator according to Example of the present disclosure;

FIG. 5 is a schematic of the arrangement of a support in a vacuum thermal insulator according to Comparative Example;

FIG. 6 shows a process of manufacturing a vehicle part according to an embodiment of the present disclosure; and

FIG. 7 shows a process of joining a roof duct made of the vacuum thermal insulator according to the present disclosure to a headlining.

FIG. 8 shows a process of joining a roof duct made of the vacuum thermal insulator according to the present disclosure to a headlining.

### DETAILED DESCRIPTION

Hereinafter, a detailed description will be given of embodiments of the present disclosure with reference to the accompanying drawings. Specific structural and functional descriptions of embodiments of the present disclosure are merely illustrative for the purpose of explaining the embodiments according to the concept of the present disclosure, and embodiments of the present disclosure may be implemented in various forms. Moreover, the present disclosure should not be construed as being limited to the embodiments described in this specification, and should be understood to include all changes, equivalents, and substitutes included in the spirit and technical scope of the present disclosure.

Meanwhile, it will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element.

It will be understood that when an element is referred to as being “coupled” or “connected” to another element, it can be directly coupled or connected to the other element or intervening elements may be present therebetween. In contrast, it should be understood that when an element is referred to as being “directly coupled” or “directly connected” to another element, there are no intervening elements present. Other expressions that explain the relationship between elements, such as “between,” “directly between,” “adjacent to,” or “directly adjacent to,” should be construed in the same way.

Throughout the specification, the same reference numerals denote the same or like elements. Meanwhile, the terms used in the present specification are intended to describe the embodiments and are not intended to limit the present disclosure. As used herein, the singular forms are intended to include the plural forms as well, unless the context clearly indicates otherwise. It will be further understood that the terms “comprises” and/or “comprising” used herein specify the presence of stated elements, steps, operations, and/or devices, but do not preclude the presence or addition of other elements, steps, operations, and/or devices.

In electric vehicles, an internal combustion engine that may be used as a heat source and power source (drive source such as a compressor or pump) is absent, and electric heaters, electric compressors, electric pumps, etc. have to be used, and thus the use of electric energy is very high compared to general internal combustion engine vehicles.

In particular, for electric vehicles, the proportion of energy consumed for cooling and heating is high, resulting in high driving range loss. Hence, it is essential to improve thermal efficiency through indoor heat management.

To this end, applying vacuum thermal insulators to vehicle parts is being considered, but when using known vacuum thermal insulators, it is difficult to mold or process the same into a desired shape due to initial rigidity.

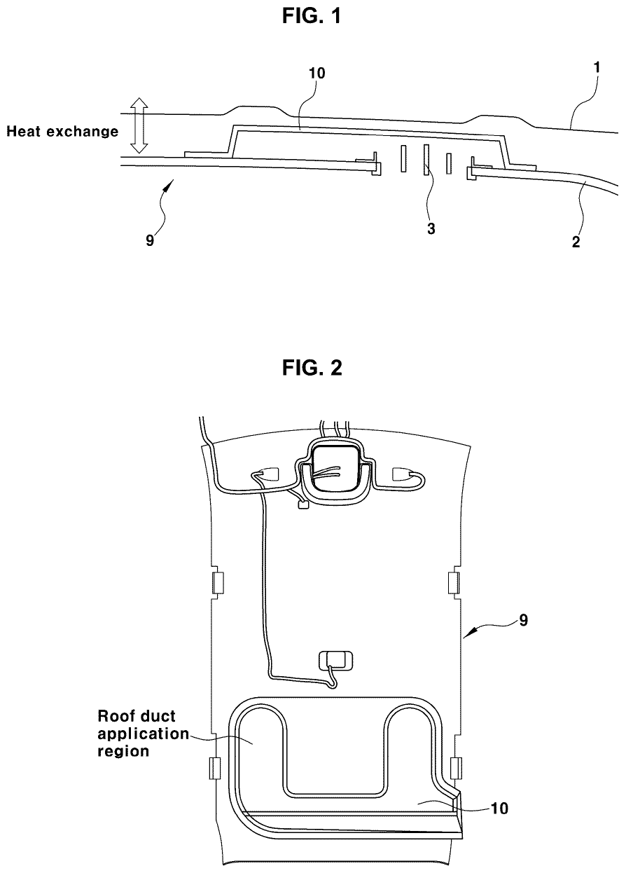

FIG. 1 is a cross-sectional view showing a part to which a vacuum thermal insulator according to the present disclosure is applied, and is a cross-sectional view of a roof structure 9 constructed by installing a roof duct 10 to the headlining 2 of a vehicle.

As shown, heat exchange occurs between inside and outside of the vehicle through the roof panel 1 of the vehicle, and the roof duct 10 for air conditioning is attached to the outer surface of the headlining, which is the non-exposed surface of the headlining 2.

The outer surface of the headlining is the upper surface of the headlining 2 in the drawing. If the surface exposed to the interior in the headlining 2 is the inner surface based on the inside of the vehicle, the opposite surface thereof, namely the outer surface based on the inside of the vehicle among both surfaces of the headlining, is the outer surface of the headlining to which the roof duct 10 is installed.

The roof duct 10 is a part for air conditioning installed to the outside of the headlining 2 in a vehicle, and is a part configured to receive heated air for indoor heating or cooled air for indoor cooling from an air conditioning device (not shown) and guide the same to a roof vent 3 for discharge inside.

When the roof duct 10 is installed to the outer surface of the headlining 2, a flow path space through which air is guided is formed by the outer surface of the headlining 2 and the inner surface of the roof duct 10, and the air supplied from the air conditioning device moves along the flow path space and is guided to the roof vent 3 and then discharged to the vehicle inside from the roof vent 3.

The internal space of the roof duct 10 as the flow path space communicates with the inside of the vehicle through the opening of the headlining 2 and the roof vent 3 provided to the opening. By virtue of this structure, heat may flow to the inside of the vehicle through the roof duct 10 and the roof vent 3 from the outside of the vehicle during the summer. Conversely, in winter, heat may be lost to the outside of the vehicle through the roof vent 3 and the roof duct 10 from the vehicle inside.

In order to prevent such heat inflow and heat loss, the roof duct 10 must be made of a material with low thermal conductivity and excellent thermal insulation performance. In the present disclosure, both the roof thermal insulation effect and air conditioning performance may be improved using the roof duct 10 made of the vacuum thermal insulator. In addition, the use of the roof duct 10 made of the vacuum thermal insulator makes it possible to improve thermal efficiency and comfort of the vehicle inside, improve energy efficiency, and increase driving range.

The portion where heat inflow and heat loss are large in a vehicle is glass, followed by the roof, doors, and floor. Considering that large heat inflow and heat loss may occur in the roof, in the present disclosure, the roof duct 10, which is the main path for heat inflow and heat loss, is manufactured using a vacuum thermal insulator with excellent thermal insulation performance. The vacuum thermal insulator has much lower thermal conductivity than PET felt or polyurethane (PU) foam.

FIG. 2 shows the application state of a vehicle part to which the vacuum thermal insulator according to the present disclosure is applied, and is a plan view showing a state in which the roof duct 10, which is a vehicle part to which the vacuum thermal insulator is applied, is installed to the roof structure 9. As shown, the roof structure includes a roof duct attached and installed to the outer surface of a predetermined region in the headlining.

In FIG. 2, the shape of the roof duct 10 or the roof structure 9 including the same is illustrative, and the present disclosure is not limited to the illustrated example, and the shape of the roof duct 10 or the roof structure 9 may be changed.

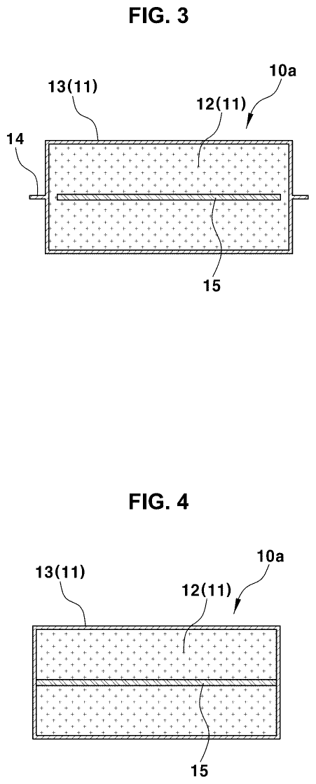

FIG. 3 is a cross-sectional view showing the configuration of the vacuum thermal insulator according to an embodiment of the present disclosure. In FIG. 3, reference numeral ‘14’ indicates an edge portion of the outer shell material 13 of the vacuum thermal insulator 10a, which will be described later. The vacuum thermal insulator 10a may be used as an interior material for a vehicle, or may be used to manufacture a vehicle part having a predetermined shape, such as a roof duct.

As shown, the vacuum thermal insulator 10a according to an embodiment of the present disclosure includes a vacuum insulation layer 11 which includes a thermal insulator 12 and in which the internal space where the thermal insulator 12 is located is maintained in a vacuum, and a shape-maintaining support 15 disposed in a structure inserted into the thermal insulator 12 of the vacuum insulation layer 11.

Here, the support 15 is used by being molded and processed to have a predetermined 3D shape, and serves as a fixed layer that maintains the shape of the part in the vacuum thermal insulator 10a and supports vacuum pressure while enabling the 3D shape of the part to be realized. The support 15 may be made of a metal plate that may be molded into a predetermined shape.

In the present disclosure, the support 15 may be made of a metal plate containing aluminum. In cases in which a pure aluminum plate is used as the support 15, it is difficult to sufficiently perform the role of supporting the shape thereof due to insufficient strength, and in particular, shape changes may be caused by vacuum.

Accordingly, in an embodiment of the present disclosure, the support 15 may be made of an aluminum alloy plate mainly containing aluminum (AI), or may be made of a stainless steel (SUS) plate that is an alloy plate mainly containing iron (Fe) as a lightweight alloy plate.

Also, the support 15 may be manufactured by press-molding a metal plate into a predetermined 3D shape, taking into account a desired part shape. Here, the metal plate may be a perforated plate with a plurality of holes formed therein.

After forming the holes at a predetermined size and interval in a metal plate by perforation, the perforated metal plate is press-molded to manufacture the support 15 having a desired shape. As such, the holes may be formed at a regular size and interval in the metal plate.

The vacuum insulation layer 11 includes a thermal insulator 12 stacked on each of both sides of the support 15, and an outer shell material 13 configured to seal the thermal insulator 12 to surround the same in a vacuum. Here, the outer shell material 13 may have gas barrier properties so that the internal space in which the thermal insulator 12 and the support 15 are accommodated may be maintained in a vacuum.

The vacuum thermal insulator 10a thus configured may be manufactured by stacking the thermal insulator 12 on each of both sides of the support 15, stacking the outer shell material 13 on the outer surface of the thermal insulator, and then integrally joining the thermal insulator 12, the outer shell material 13, and the support by a vacuum compression process.

Glass wool may be used as the thermal insulator 12, and fiber-type low-weight glass wool is stacked on each of both sides of the support 15, after which the outer shell material 13 is stacked around the glass wool, followed by vacuum compression, thereby integrating the support 15, the thermal insulator 12, and the outer shell material 13.

A composite film with metal stacked may be used as the outer shell material 13 joined to the outer surface of the thermal insulator. Specifically, an aluminum composite film in which aluminum (Al) is stacked to a predetermined thickness on the surface of a film material may be used.

Here, the aluminum composite film may be manufactured by depositing aluminum (Al) to a predetermined thickness on the surface of the film material by an aluminum deposition process. This outer shell material 13 may serve to seal the thermal insulator 12, maintain the vacuum degree of the vacuum insulation layer 11, and reflect heat transferred from the outside.

The film material of the outer shell material 13 may be a polyolefin film, and when an outer shell material with a metal deposited on a polyolefin film is used, the gas barrier properties of the outer shell material may be further improved, so that the vacuum state of the vacuum insulation layer 11 may be maintained for a long period of time.

Although the use of the aluminum composite film with aluminum deposited on the surface of the film material as the outer shell material 13 is described above, a metal composite film, in which any one metal selected from the group consisting of gold, silver, copper, nickel, cobalt, chromium, and tin, instead of aluminum, is deposited on the surface of the film material, may be used as the outer shell material.

Thereby, a vehicle part, which is formed of the vacuum thermal insulator 10a described above so that changes in thermal characteristics may be minimized and excellent thermal insulation effects between vehicle inside and outside may be exhibited, for example, a thermal insulation roof duct installed to the roof of a vehicle to reduce heat inflow and heat loss between inside and outside, may be provided.

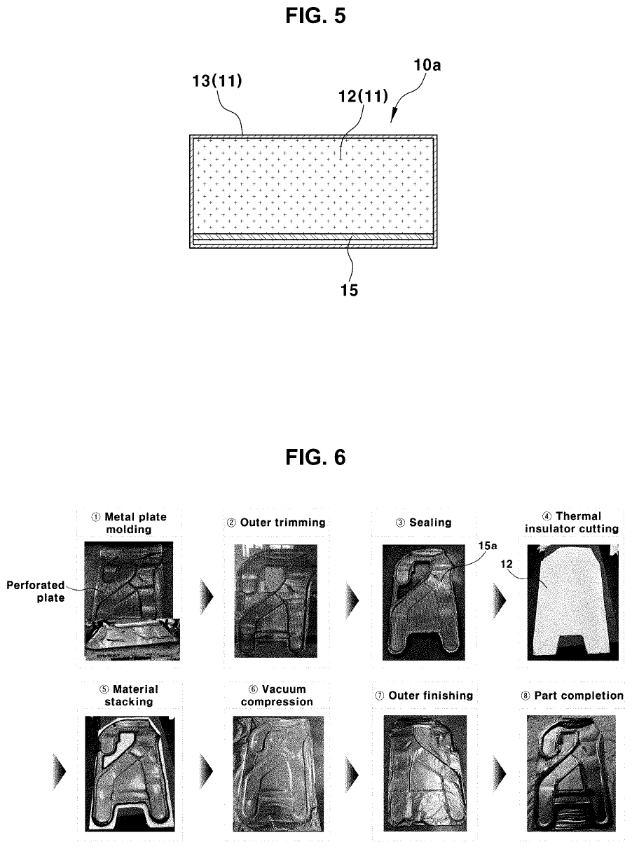

FIG. 4 is a schematic of the arrangement of a support in a vacuum thermal insulator according to Example of the present disclosure, and FIG. 5 schematically shows the arrangement of a support in a vacuum thermal insulator according to Comparative Example.

As shown in FIG. 4, after stacking the thermal insulator 12 on each of both sides of the support 15, the outer shell material 13 is vacuum compressed to completely surround the stacked thermal insulator 12, completely integrating the support 15 and the thermal insulator 12. Thereby, a vacuum thermal insulator 10a having a plate shape with a predetermined thickness may be manufactured.

In the vacuum thermal insulator 10a according to Example of the present disclosure, the support 15 and the outer shell material 13 are not in direct contact with each other. Specifically, the support 15 is located in the internal space of the vacuum insulation layer 11 and is inserted into approximately the middle position between outer shell materials 13 and thermal insulators 12 at both sides in the thickness direction of the vacuum thermal insulator, and even in the vacuum compressed state, the support 15 and the outer shell material 13 are spaced apart from each other as a whole with the thermal insulator 12 interposed therebetween.

However, as in Comparative Example of FIG. 5, when the support 15 and the outer shell material 13 in the vacuum thermal insulator 10a are in direct contact with each other, a problem may occur in which the outer shell material 13 is torn at the corners of the support 15.

Accordingly, the thermal insulator 12 is preferably interposed between the support 15 and the outer shell material 13. As such, the support 15 is preferably located at the middle position between outer shell materials 13 at both sides in the vacuum insulation layer 11.

FIG. 6 shows the process of manufacturing the vehicle part according to an embodiment of the present disclosure, including steps of manufacturing a roof duct made of the vacuum thermal insulator according to the present disclosure.

As shown in FIG. 6, molding a metal plate serving as the support is first performed (\textcircled{1}). Here, after manufacturing a perforated plate by perforation of the metal plate, the perforated plate is pressed and molded into a predetermined shape taking into account the shape of a roof duct.

Next, outer trimming is performed to remove unnecessary portions from the molded metal plate (\textcircled{2}), and a sealing process for applying an adhesive such as a heat-resistant hot melt, etc., for bonding to the thermal insulator, onto a predetermined portion such as an edge portion, etc. of the metal plate (perforated plate) 15a subjected to outer trimming is performed (\textcircled{3}).

Next, the thermal insulator 12 having a predetermined thickness is cut into a required size and shape (\textcircled{4}), and the thermal insulator 12 is stacked on each of both sides of the metal plate 15a (\textcircled{5}). In addition, with the thermal insulator stacked on the metal plate, an outer shell material is stacked on the outer surface of the thermal insulator. Here, the outer shell material having a size that may completely cover the thermal insulator at each side is stacked.

Next, the metal plate 15a (which is a support), the thermal insulator 12, and the outer shell material, which are stacked, are placed in a vacuum exhaust device to have a vacuum of a predetermined pressure level, and all the gas and moisture contained in the inside sealed with the outer shell material and the thermal insulator are discharged to the outside and the outer shell material is sealed (\textcircled{6}).

In this way, by performing a vacuum compression process of applying vacuum pressure between outer shell materials at both sides and applying heat and pressure to the outer shell materials, each outer shell material is vacuum compressed to the thermal insulator, integrating the support, the thermal insulator, and the outer shell material.

Here, the support, the thermal insulator, and the outer shell material, which are stacked, are molded into a plate shape having a predetermined thickness, and the edge portions of outer shell materials at both sides (reference numeral ‘14’ in FIG. 3) are fixed in a state of being thermally adhered to each other. Next, outer finishing is performed to change the incomplete shape of the external appearance into a predetermined shape by cutting and removing unnecessary portions of the outer shell materials 13 (\textcircled{7}).

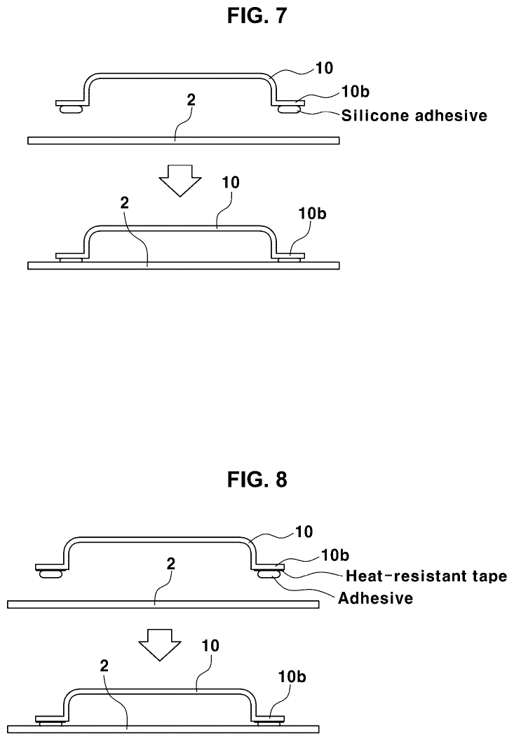

Next, a part is finally completed by performing finishing work, such as additional molding to form, into a predetermined shape, the shape of the edge portion (reference numeral ‘10b’ in FIGS. 7 and 8) or the curved portion of a roof duct (reference numeral ‘10’ in FIGS. 7 and 8 to be described later) bonded to a headlining, or additional attachment of a separate outer shell material to some portions (\textcircled{8}).

FIGS. 7 and 8 show the process of joining a roof duct made of the vacuum thermal insulator according to the present disclosure to a headlining.

In the roof duct 10, an edge portion 10b having a shape that may be adhered and fixed with seated on the outer surface of the headlining 2 is formed along the entire circumference of the edge of the roof duct, and the edge portion 10b is adhered and fixed to the outer surface of the headlining 2 using an adhesive. Here, the headlining 2 may be made of polyurethane board (PU board).

If the roof duct is made of polyurethane as in conventional cases, a heat-resistant hot melt may be applied as an adhesive onto the edge portion of the roof duct, and then the edge portion of the roof duct may be adhered to the outer surface of the headlining by applying heat and pressure thereto, thereby fixing the edge portion of the roof duct to the outer surface of the headlining by the hot melt.

However, in the present disclosure, the roof duct 10 is manufactured using the vacuum thermal insulator (reference numeral ‘10a’ in FIG. 3) including an aluminum composite film as the outer shell material 13. Therefore, in consideration thereof, in the present disclosure, as shown in FIG. 7, a silicone adhesive is applied onto the edge portion 10b of the roof duct 10 made of the vacuum thermal insulator, and then the edge portion 10b of the roof duct 10 may be adhered and fixed to the outer surface of the headlining 2 by the silicone adhesive. Here, the silicone adhesive may be sufficiently cured at room temperature so that the roof duct 10 is firmly adhered to the outer surface of the headlining 2.

Alternatively, as shown in FIG. 8, a heat-resistant tape, for example, a heat-resistant tape made using silicone, glass fabric, or Teflon, may be adhered and fixed to the edge portion 10b of the roof duct 10, a heat-resistant hot melt as an adhesive may be applied onto the heat-resistant tape, and then the edge portion 10b of the roof duct 10 may be bonded to the headlining 2 by applying heat and pressure simultaneously, thereby adhering and fixing the edge portion 10b of the roof duct 10 to the surface of the headlining 2 by the heat-resistant hot melt.

As described above, according to the present disclosure, it is possible to manufacture a vacuum thermal insulator roof duct with excellent thermal insulation performance compared to a conventional roof duct made of polyurethane board (PU board).

In addition, it is possible to provide a vacuum thermal insulator that has excellent sound insulation and thermal insulation performance and is easy to mold or process into a desired part shape. In particular, it is possible to manufacture a vehicle part having a desired shape even with the vacuum thermal insulator that was difficult to shape due to initial rigidity.

The vacuum thermal insulator according to the present disclosure may be applied to manufacture a roof duct for air conditioning installed to a roof among vehicle parts, and when applied, it becomes possible to form a desired roof duct shape.

In addition, according to the present disclosure, the range of application of the vacuum thermal insulator to vehicle parts may be increased and expanded, and when applied, heat management efficiency of vehicles may be improved and also the driving range of vehicles may be increased.

Moreover, in the present disclosure, the thickness and size of the roof duct may be optimized by applying the vacuum thermal insulator, making it possible to sufficiently ensure and expand the vehicle internal space at the roof side.

In addition, when applying the present disclosure, even when the roof panel is heated by external heat, heat may be effectively blocked in the roof duct region to which the vacuum thermal insulator is applied, so inside comfort may be improved.

As is apparent from the above description, according to the present disclosure, it is possible to provide a vacuum thermal insulator that has excellent sound insulation performance and thermal insulation performance and is easy to mold or process into a desired part shape. In particular, it is possible to manufacture a vehicle part having a desired shape even with the vacuum thermal insulator that was difficult to shape due to initial rigidity.

The vacuum thermal insulator according to the present disclosure can be applied to manufacture a roof duct for air conditioning installed to a roof among vehicle parts, and when applied, it becomes possible to form a desired roof duct shape.

In addition, according to the present disclosure, the range of application of the vacuum thermal insulator to vehicle parts can be increased and expanded, and when applied, heat management efficiency of vehicles can be improved and also the driving range of vehicles can be increased.

As the examples of the present disclosure have been described in detail above, the scope of the present disclosure is not limited to the aforementioned examples, and various modifications and improvements made by those skilled in the art using the basic concept of the present disclosure defined in the following claims are also within the scope of the present disclosure.

What is claimed is:

1. A vacuum thermal insulator, comprising:
a thermal insulator;
a support disposed in the thermal insulator and configured to maintain a product shape of the vacuum thermal insulator; and
an outer shell material configured to surround the thermal insulator and joined to an outer surface of the thermal insulator in a vacuum compressed state to seal and maintain an internal space in which the thermal insulator and the support are accommodated in a vacuum.

2. The vacuum thermal insulator of claim 1, wherein the support is a perforated metal plate with a plurality of holes formed therein and molded into a predetermined shape in consideration of the product shape of the vacuum thermal insulator.

3. The vacuum thermal insulator of claim 2, wherein the support comprises an aluminum alloy plate or a stainless steel plate.

4. The vacuum thermal insulator of claim 1, wherein the outer shell material is a metal composite film in which any one metal selected from the group consisting of aluminum, gold, silver, copper, nickel, cobalt, chromium, and tin is stacked on a surface of a film material.

5. The vacuum thermal insulator of claim 1, wherein the support and the outer shell material are spaced apart with the thermal insulator interposed therebetween so as not to be in contact with each other.

6. The vacuum thermal insulator of claim 1, which is provided as a vehicle part.

7. The vacuum thermal insulator of claim 6, wherein the vehicle part is a roof duct attached to a headlining and configured to receive heated air for indoor heating or cooled air for indoor cooling from an air conditioning device and guide the air to a roof vent for discharge inside.

8. A method of manufacturing a vehicle part, comprising:
manufacturing a perforated plate with a plurality of holes formed therein by perforating a metal plate;
molding the perforated plate into a predetermined shape in consideration of a shape of a part;
applying an adhesive onto a predetermined portion comprising an edge portion of the perforated plate;
stacking a thermal insulator on each of both sides of the perforated plate and stacking an outer shell material on an outer surface of the stacked thermal insulator; and
performing a vacuum compression process of applying vacuum pressure between outer shell materials at both sides and applying heat and pressure to the outer shell materials,
wherein a support made of the perforated plate is disposed in the thermal insulator, and the outer shell material is configured to surround the thermal insulator and joined to the outer surface of the thermal insulator in a vacuum compressed state to seal and maintain an internal space in which the thermal insulator and the support are accommodated in a vacuum.

9. The method of claim 8, wherein the metal plate is an aluminum alloy plate or a stainless steel plate.

10. The method of claim 8, wherein the outer shell material is a metal composite film in which any one metal selected from the group consisting of aluminum, gold, silver, copper, nickel, cobalt, chromium, and tin is stacked on a surface of a film material.

11. The method of claim 8, wherein, in performing the vacuum compression process, the support and the outer shell material after vacuum compression are spaced apart with the thermal insulator interposed therebetween so as not to be in contact with each other.

12. The method of claim 8, wherein the vehicle part is a roof duct attached to a headlining and configured to receive heated air for indoor heating or cooled air for indoor cooling from an air conditioning device and guide the air to a roof vent for discharge inside.

13. A roof structure, comprising:
a roof duct comprising a thermal insulator, a support disposed in the thermal insulator and configured to maintain a shape of a part, and an outer shell material configured to surround the thermal insulator and joined to an outer surface of the thermal insulator in a vacuum compressed state to seal and maintain an internal space in which the thermal insulator and the support are accommodated in a vacuum; and
a headlining to which the roof duct is attached,
wherein an edge portion of the roof duct is adhered and fixed to the headlining by an adhesive.

14. The roof structure of claim 13, wherein the adhesive is a silicone adhesive.

15. The roof structure of claim 13, wherein a heat-resistant tape is adhered and fixed to the edge portion of the roof duct, and the roof duct is adhered and fixed to the headlining by the adhesive applied onto the heat-resistant tape.
